(19) United States
(12) Patent Application Publication
(10) Pub. No.: US 2015/0100326 A1
(43) Pub. Date: Apr. 9, 2015

(54) HEALTHCARE VISIT MANAGEMENT FRAMEWORK

(71) Applicants: Marek Konrad KOWALKIEWICZ, Singapore (SG); Andreas Kurt PURSCHE, Singapore (SG); Inez CAHYANI, Singapore (SG); Abraham Sasmito ADIBOWO, Singapore (SG)

(72) Inventors: Marek Konrad KOWALKIEWICZ, Singapore (SG); Andreas Kurt PURSCHE, Singapore (SG); Inez CAHYANI, Singapore (SG); Abraham Sasmito ADIBOWO, Singapore (SG)

(21) Appl. No.: 14/044,887

(22) Filed: Oct. 3, 2013

(51) Int. Cl. G06Q 50/22; G06Q 10/06

(52) U.S. Cl. CPC G06Q 50/22; G06Q 10/06
USPC 705/2

(57) ABSTRACT

Described herein is a descriptive framework to facilitate healthcare visit management. In accordance with one aspect, information of an appointment scheduled with a healthcare provider is received. A user's real-time location is monitored and the user's real-time location is used to facilitate a visit to fulfill the appointment. If waiting time of the user during the visit is estimated to be more than a predetermined threshold value, one or more recommendations may be presented via a user device to recommend relevant services, goods or entertainment options to the user.

### TECHNICAL FIELD

The present disclosure relates generally to computer systems, and more specifically, to a framework for healthcare visit management.

### BACKGROUND

Customer satisfaction is an important metric in evaluating the quality of healthcare services. In addition, waiting time is one of the strongest predictor for patient satisfaction with healthcare services. Unfortunately, patients often spend more time waiting in line to receive healthcare services or between medical procedures. Long waiting times and crowded waiting rooms only serve to add anxiety to the patient and increase the drop-off rate of patients seeking healthcare. In some cases, patients may even charge back to healthcare providers the cost of lost time and productivity.

Accordingly, there is a need to enhance the overall experience of the patient in receiving healthcare so as to improve the patient's satisfaction and reduce costs associated with large crowded waiting areas and high patient drop-off rate.

### SUMMARY

A framework for facilitating healthcare visit management is described herein. In accordance with one aspect of the framework, information of an appointment scheduled with a healthcare provider is received. A user's real-time location is monitored and the user's real-time location is used to facilitate a visit to fulfill the appointment. If waiting time of the user during the visit is estimated to be more than a predetermined threshold value, one or more recommendations may be presented via a user device to recommend relevant services, goods or entertainment options to the user.

In accordance with another aspect of the framework, a healthcare need description associated with a user is received. The framework may generate a list of recommended healthcare providers relevant to the healthcare need description. The framework may further receive, via a user device, a user selection of the healthcare provider from the list. The framework may then request an appointment with the selected healthcare provider and facilitate a visit to fulfill the appointment.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows exemplary components of a healthcare visit management engine;

FIG. 3 shows an exemplary method of healthcare visit management;

FIG. 4 shows an exemplary dashboard for receiving healthcare need description;

FIG. 5 shows an exemplary dashboard for managing a family profile;

FIG. 6 shows an exemplary confirmation notification of an appointment;

FIG. 7 shows an exemplary health alert;

FIG. 8 shows an exemplary method of generating a healthcare need description;

FIG. 9 shows an exemplary method of automatically generating a list of recommended healthcare providers;

FIG. 10a shows an exemplary dashboard for presenting a list of recommended healthcare providers;

FIG. 10b shows an exemplary dashboard for presenting a review of a healthcare provider;

FIG. 10c shows an exemplary dashboard for receiving user feedback about a healthcare provider;

FIG. 11 shows an exemplary method of requesting for an appointment;

FIG. 12 shows an exemplary method of facilitating a visit to a healthcare provider and generating value-added recommendations during the visit;

FIG. 13a shows an exemplary appointment alert;

FIG. 13b shows an exemplary dashboard for providing navigational aid;

FIG. 14 shows an exemplary dashboard that provides a recommendation for a massage service; and

FIG. 15 shows another exemplary appointment alert.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for managing healthcare visits is described herein. In accordance with one aspect of the framework, a set of services for facilitating a visit with a healthcare provider (hereinafter “healthcare visit”) is provided. The set of services may be provided to the user via, for example, a mobile software application implemented in a user device. The services may include, but are not limited to, family health record-keeping and sharing with healthcare providers, social data collection and distribution (e.g., reviews, recommendations, ratings of healthcare providers, etc.) for better informed decision-making, dynamic scheduling of healthcare appointments, context-based alerts (e.g., appointment alerts), outdoor and/or indoor navigation aids, entertainment options and/or recommendations of value-added services during waiting time on day of appointment, and/or integrated billing and payment functions.

The present framework advantageously focuses on improving the overall patient experience with the healthcare provider, which is an area that is often overlooked by many healthcare institutions. More particularly, it focuses on the operational aspect rather than the medical aspect of the healthcare industry. Caregivers and patients are able to have a single point of contact for addressing their healthcare needs, make informed decisions on which healthcare provider to approach, and so forth. In addition, healthcare providers are able to obtain valuable feedback from patients that they can use to improve their services.

One aspect of the framework supports dynamic scheduling of simple and composite appointments. A simple appointment includes a single appointment item, whereas a composite appointment contains multiple appointment items within the overall time-span of the appointment. Different appointment items may be associated with different dates, times, venues, departments within a venue, healthcare resources, healthcare recipients and/or healthcare providers. The appointment items may be interdependent such that the occurrence of any change in an appointment item may cause the framework to dynamically re-schedule other appointment items. These and other advantages and features will be described in more detail herein.

It should be noted that “healthcare providers” as used herein generally refers to suppliers of resources (e.g., goods or services) for the diagnosis, treatment, and/or prevention of disease, illness, injury, and other physical and mental impairments. Exemplary healthcare providers include, but are not limited to, doctors, physicians, specialists, dentists, chiropractors, psychologists, counselors, nurses, technicians, therapists, physician's assistant, midwife, pharmacists, audiologists, and so forth. It should further be appreciated that the framework described herein may be implemented as a method, a computer-controlled apparatus, a computer process, a computing system, or as an article of manufacture such as a computer-usable medium. These and various other features will be apparent from the following description.

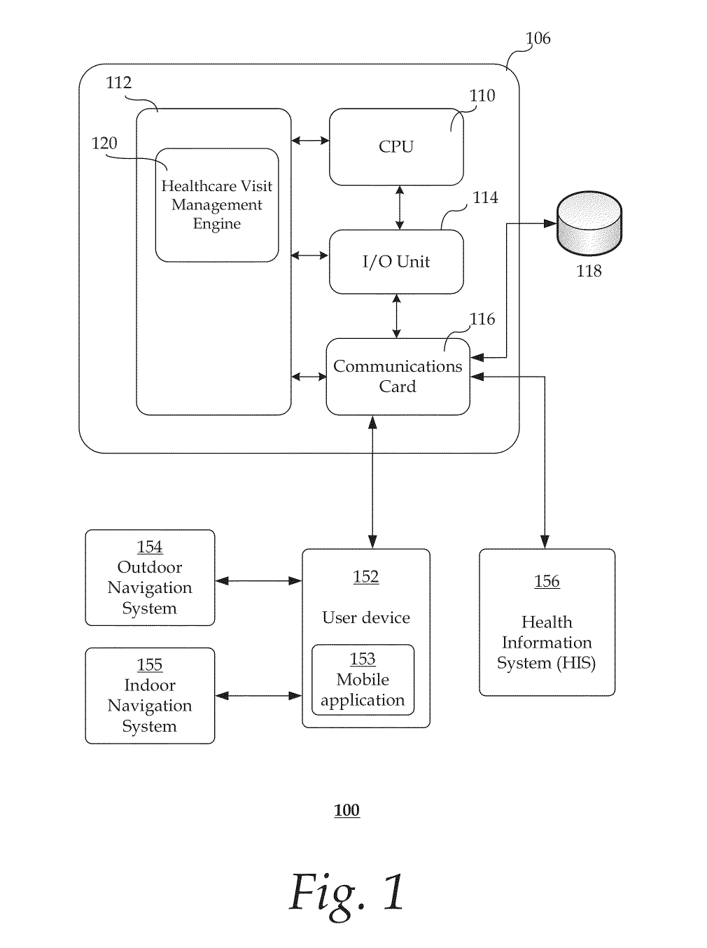

FIG. 1 is a block diagram illustrating an exemplary architecture 100 in accordance with one aspect of the present framework. Generally, exemplary architecture 100 may include a computer system 106, a data repository 118, a user device 152 and a health information system (HIS) 156.

Computer system 106 can be any type of computing device capable of responding to and executing instructions in a defined manner, such as a workstation, a server, a portable laptop computer, another portable device, a mini-computer, a mainframe computer, a storage system, a dedicated digital appliance, a device, a component, other equipment, or some combination of these. Computer system 106 may include a central processing unit (CPU) 110, an input/output (I/O) unit 114, a memory module 112 and a communications card or device 116 (e.g., modem and/or network adapter) for exchanging data with a network (e.g., local area network (LAN), wide area network (WAN), Internet, etc.). It should be appreciated that the different components and sub-components of the computer system 106 may be located or executed on different machines or systems. For example, a component may be executed on many computer systems connected via the network at the same time (i.e., cloud computing).

Computer system 106 may further be communicatively coupled to one or more data repositories 118. A data repository 118 may be, for example, any database (e.g., relational database, in-memory database, etc.), an entity (e.g., set of related records), or a data set included in a database. In some implementations, data repository 118 serves to store data of healthcare providers (e.g., names, office address, contact information, specializations, etc.), reviews of healthcare providers (e.g., reviews by patients, ratings, etc.), national recommendation of healthcare schedule, users' information (e.g., health profiles, contact information, etc.), and so forth.

In some implementations, data repository 118 is implemented as an in-memory database. In-memory databases allow seamless access to and propagation of high volumes of data in real time. Parallel processing may further be achieved by using a multicore processor in conjunction with the in-memory database 118. The in-memory database 118 is a database management system that relies primarily on a system's main memory for efficient computer data storage. More particularly, the data in the in-memory database resides in volatile memory and is not persistently stored on a hard drive, thereby allowing the data to be instantly accessed and scanned at a speed of several megabytes per millisecond.

Computer system 106 may act as a server and operate in a networked environment using logical connections to one or more user devices 152 and one or more health information systems (HIS) 156 associated with healthcare providers. Each user device 152 may be associated with one or more particular users, and serve as an interface to send and receive information from computer system 106. In some implementations, user device 152 is a mobile device that includes, but is not limited to, a smart phone, a tablet computer, a handheld laptop, a cellular device, a mobile phone, a gaming device, a portable digital assistant (PDA), a portable media player, a wireless device, a data browsing device, and so forth. User device 152 may include components similar to a computer system, such as an input device for receiving user input (e.g., touch screen, keypad, etc.), an output device for displaying a graphical user interface, a communications card, memory for storing a mobile software application (or mobile app) 153, a processor for executing the mobile app 153, and so forth.

The mobile application 153 may present one or more dashboards (or graphical user interfaces) to access one or more healthcare-related services, including services provided by a healthcare visit management engine 120. Mobile application 153 may become a useful resident of the user device 152, and by extension the user's daily life, by maintaining a regular “conversation” with the user. For instance, the user may use the mobile application 153 regularly to store and retrieve the user's family health information, schedule appointments, keep track of check-up schedules, vaccination needs, history of doctor visits, and other healthcare-related information, and so forth, as will be described in more detail herein.

In some implementations, user device 152 is communicatively coupled to an outdoor navigation system 154 and an indoor navigation system 155. Outdoor navigation system 154 provides a geographical location of the user device 152 with global coverage (e.g., outside a building). Such outdoor navigation system 154 may include satellite-based systems such as, for instance, Global Positioning System (GPS) or Global Navigation Satellite System (GLONASS). Indoor navigation system 155 provides a location of the user device 152 when it is inside a building or to provide local coverage. Instead of using satellites, the indoor navigation system 155 may rely on nearby anchors (i.e. nodes with a known position), which either actively locate tags or provide environmental context for devices to sense in order to provide location information. Exemplary indoor navigation systems 155 include, but are not limited to, radio-frequency identification (RFID) systems, Wi-Fi positioning systems, etc.

HIS 156 captures, manages and/or displays information related to the delivery of healthcare to patients (e.g., clinical information, diagnostic images, laboratory results, pharmacy prescriptions, patient information, etc.). Each HIS 156 may include one or more computer systems and software that are associated with a particular hospital, clinic or healthcare provider's office. In some implementations, the HIS 156 is communicatively coupled via a network to a staff terminal, where a hospital administrator, healthcare service professional (e.g., doctor, nurse, etc.) or any other authorized user may access and/or enter patient health information.

Memory module 112 of the computer system 106 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by CPU 110. As such, the computer system 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

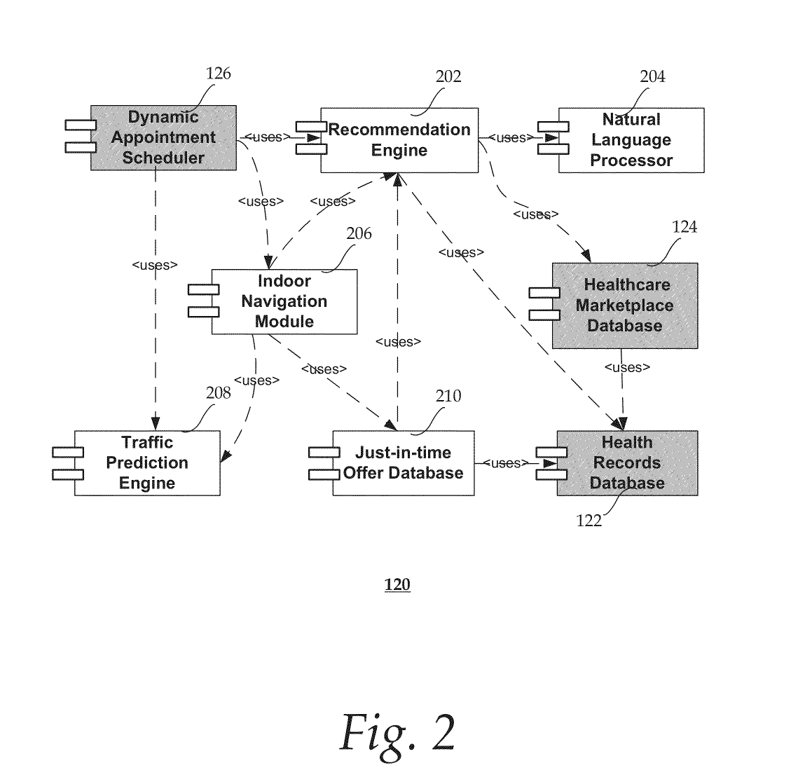

In some implementations, memory module 112 of the computer system 106 includes a healthcare visit management engine 120 for implementing the techniques described herein. FIG. 2 shows exemplary components of the healthcare visit management engine 120. As shown, the healthcare visit management engine 120 may include, but is not limited to, a health records database 122, a healthcare marketplace database 124, a dynamic appointment scheduler 126. These components may include or operate in conjunction with, for example, a recommendation engine 202, a natural language processor 204, an indoor navigation module 206, a traffic prediction engine 208 and a just-in-time offer database 210. It should be appreciated that some or all of these components may also be implemented in another computer system.

Health records database 122 may serve to provide secure storage and retrieval of health records of each user and/or one or more of the user's family members. Dynamic appointment scheduler 126 generally facilitates the user (or the user's family members) in procuring healthcare, while the healthcare marketplace database 124 may serve to provide access to a pool of healthcare providers. It should be noted that the term “user”, as used herein, may generally refer to a patient, a healthcare recipient, a particular user of the healthcare-related services provided by the present framework, or a family member of the user. The user may be the primary caregiver of the family (e.g., wife, mother, father, etc.), while a family member may be an individual within the user's immediate family (e.g., spouse, son, daughter, brother, sister, mother, father, etc.) or extended family (e.g., grandson, granddaughter, cousin, grandmother, grandfather, etc.). In addition, the family member may be an individual who is not related to the user by law or blood, but is still identified as a family member (e.g. close friend, domestic worker, etc.) of the user.

Recommendation engine 202 serves to generate relevant healthcare-related recommendations. To provide a pro-active system, recommendation engine 202 may use data from multiple databases. For instance, recommendation engine 202 may retrieve a health record from health records database 122, and search for offers stored in just-in-time offer database 210 that are relevant to a particular user's health record. In another example, recommendation engine 202 may receive a patient's complaint from the user device 152, use the natural language processor 204 to parse (or mine) the patient's complaint to extract keywords, and search the healthcare marketplace database 124 using the keywords so as to generate a list of relevant doctors or other healthcare providers.

Once an appointment is scheduled, traffic prediction engine 208 may estimate the travel time of a user from his or her current location to the healthcare provider's venue (e.g., hospital) and send context-based alerts to the user device 152 as necessary. Traffic prediction engine 208 may use location data streamed from the outdoor navigation system 154 via the user device 152 to determine the current location of the user.

Once the user reaches the venue, the indoor navigation module 206 may retrieve location data from the indoor navigation system 155 and provide navigational aids (e.g., turn-by-turn directions, maps, etc.) to facilitate the user in reaching the appropriate clinic or office within the venue. If the waiting time for the patient is estimated to be relatively long, indoor navigation module 206 may operate in conjunction with the recommendation engine 202 and the just-in-time offer database 210 to provide relevant in-house diversions and/or entertainment options. Accordingly, these components advantageously shorten and/or optimize the user's waiting time, while keeping the healthcare provider's utilization rate and patient satisfaction high. These and other exemplary features will be described in more detail herein.

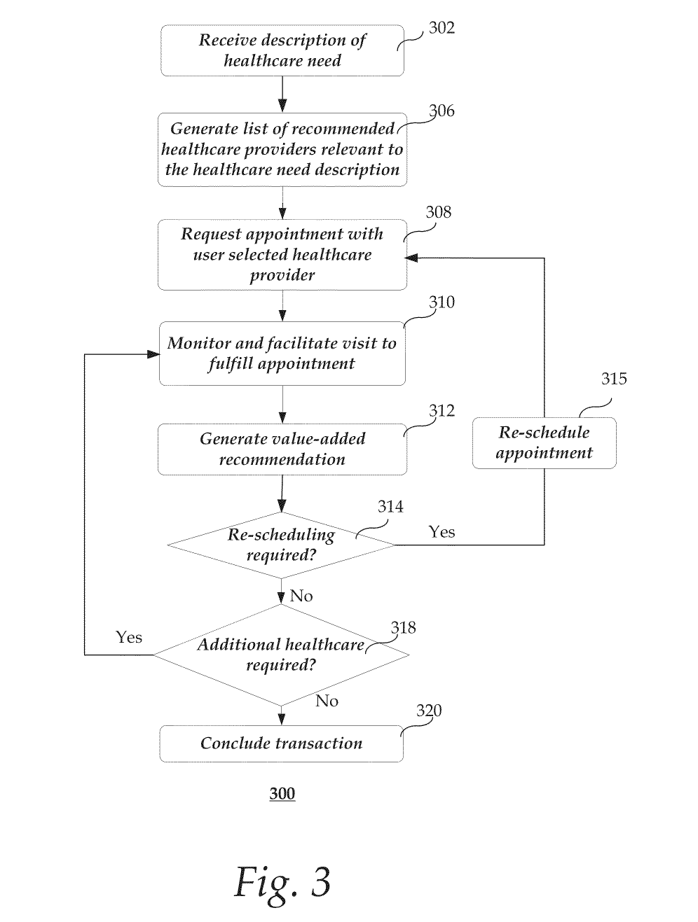

FIG. 3 shows an exemplary method 300 of healthcare visit management. The method 300 may be performed automatically or semi-automatically by the computer system 106, as previously described with reference to FIGS. 1 and 2. It should be noted that in the following discussion, reference will be made, using like numerals, to the features described in FIGS. 1 and 2.

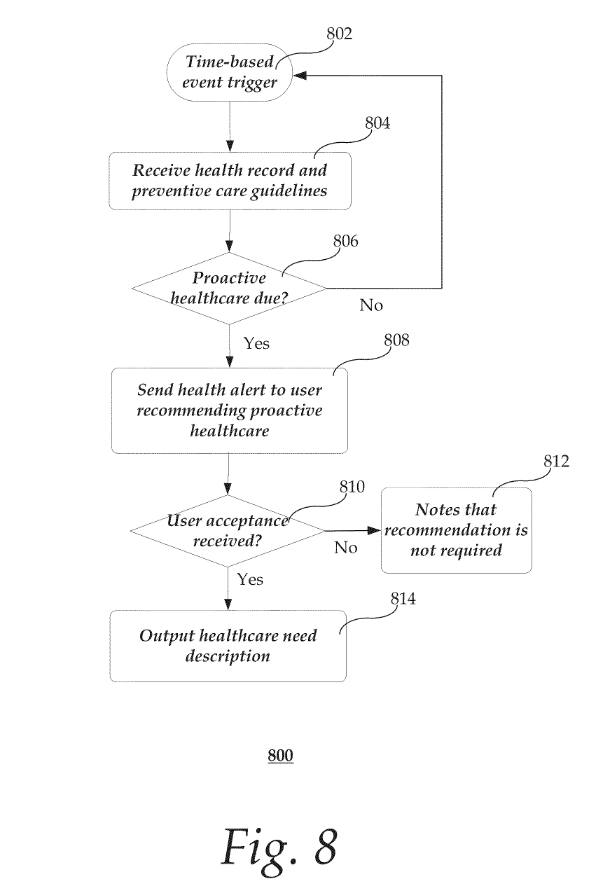

At 302, the recommendation engine 202 receives description data of a healthcare need associated with a user or a user's family member. The description data may be, for instance, a text description of a desired healthcare procedure, a health-related problem, an illness or symptoms associated with the illness (e.g., coughing, sore throat, etc.). The healthcare need may be associated with, for instance, emergency care, urgent care, routine check-up, non-emergency care, schedule procedure, laboratory test, etc. In some implementations, a user may input the healthcare need description via user device 152. In other implementations, the healthcare need description is automatically generated based on the health record of the user or the user's family member, as will be described in more detail with reference to FIG. 8.

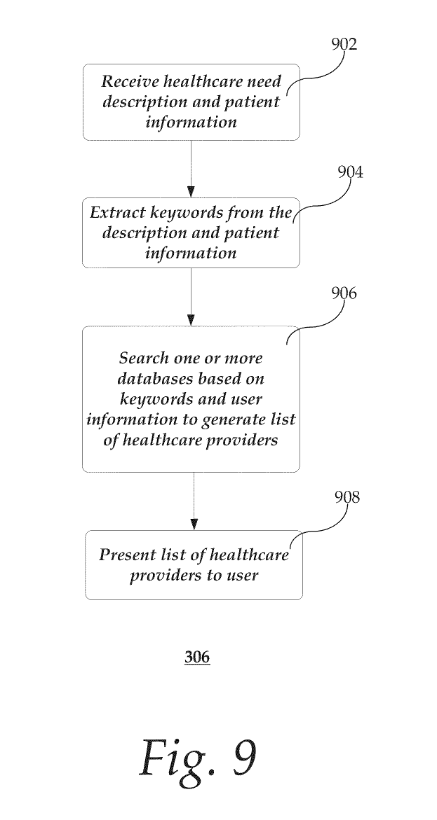

At 306, the recommendation engine 202 generates a list of recommended healthcare providers based on the healthcare need description. The list of recommended healthcare providers may be generated by searching the healthcare marketplace database 124 based on one or more keywords, as will be described in more detail with reference to FIG. 9.

At 308, the dynamic appointment scheduler 126 receives a user selection of a healthcare provider and proceeds to request for an appointment with the healthcare provider. It should be appreciated that the “appointment” may be a simple or composite appointment, as previously described. A simple appointment includes a single appointment item, whereas a composite appointment contains multiple appointment items within the overall time-span of the appointment. Each appointment item may be defined by a time, venue, healthcare resource and healthcare recipient.

Different appointment items may be associated with different dates, times, venues, departments within a venue, healthcare resources, healthcare recipients and/or healthcare providers. For example, a composite appointment may be associated with a single healthcare recipient and multiple visits to the different healthcare providers (e.g., radiologist, therapist, oncologist, etc.) spread over a time-span. As another example, a composite appointment may be associated with multiple healthcare recipients (e.g., family members) visiting different healthcare providers at the same venue on the same day. This enables, for instance, a primary caregiver (e.g., mother) to accompany multiple healthcare recipients (e.g., children) to the same venue for a joint visit so as to optimize time and resources. This is possible since the dynamic appointment scheduler 126 is aware of the time constraints associated with the multiple appointment items, and is therefore able to schedule the items to avoid scheduling conflict.

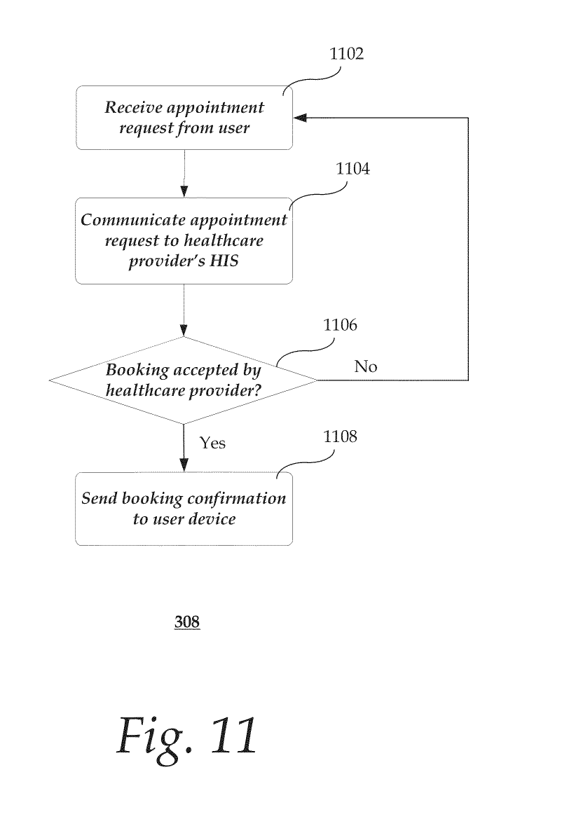

For each appointment item of the simple or composite appointment, the dynamic appointment scheduler 126 may send an appointment request to the healthcare provider to book the appointment. An exemplary method of requesting for an appointment will be described in more detail with reference to FIG. 11.

At 310, the dynamic appointment scheduler 126 monitors and facilitates the visit to the healthcare provider to fulfill the appointment (e.g., on the day of the appointment). The dynamic appointment scheduler 126 may invoke the traffic prediction engine 208 and the indoor navigation module 206 to assist in monitoring and facilitating the visit, as will be described in more detail later.

At 312, the recommendation engine 202 may generate one or more relevant recommendations and present them to the user while the user waits. The recommendations may be related to, for example, value-added services (e.g., preventive care) or entertainment options. In some implementations, the recommendations are generated based on information retrieved from the just-in-time offer database 210, as will be described in more detail later.

At 314, the dynamic appointment scheduler 126 determines if re-scheduling of the appointment is required. This may be necessary when, for instance, the user cannot arrive on-time (e.g., late or early) at the venue of the healthcare provider, the waiting period is too long, the healthcare provider cancels the appointment, etc. Based on the user's current location and optionally the traffic information, the dynamic appointment scheduler 126 may estimate the time of arrival of the user at the healthcare provider's venue, and determine if the user is going to arrive too early or late for the appointment and whether re-scheduling is required. The user may be presented with an option to re-schedule the appointment or to book a faster mode of transportation.

If re-scheduling is required, at 315, the dynamic appointment scheduler 126 may re-schedule the appointment. For example, if the user will be too late (or early) for the appointment, the appointment may be re-scheduled to a later or earlier time. In the case of a composite appointment, the appointment items in the composite appointment may be inter-dependent, such that changes or delays in earlier appointment items may directly affect the later appointment items. While re-scheduling, the dynamic appointment scheduler 126 may take into account such inter-dependencies and re-schedule the current as well as the later appointment items while avoiding scheduling conflicts in time. In some cases, it may be possible to re-arrange the temporal order of appointment items by inter-changing some appointment items without causing any scheduling conflict. For instance, in a composite appointment in which the user is to visit a first specialist and a second specialist consecutively, if the user is late for appointment with the first specialist, he or she may be re-scheduled to visit the second specialist first followed by the first specialist. Steps 308, 310, 312 and 314 may then be repeated for the re-scheduled appointment.

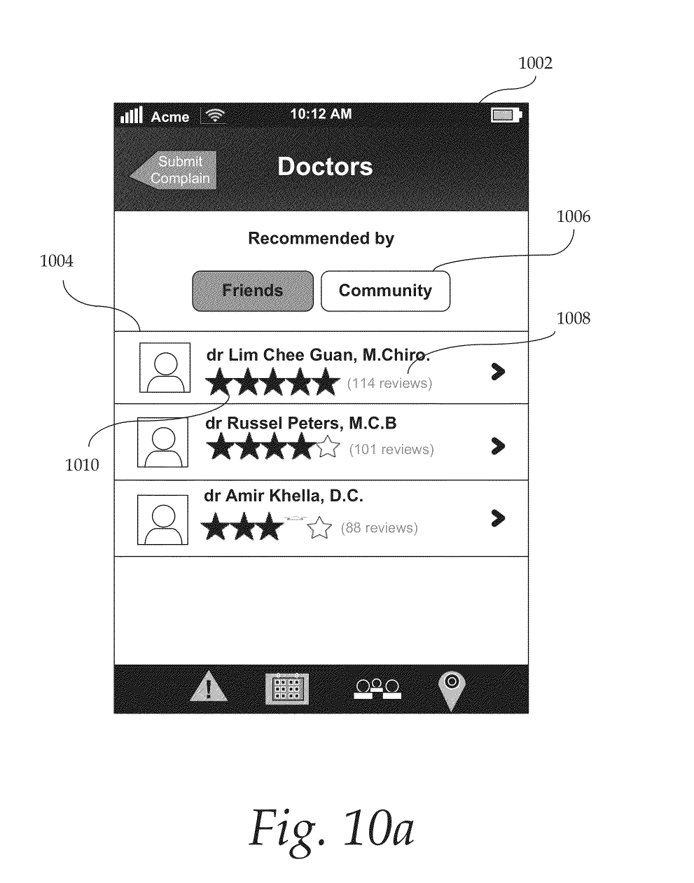

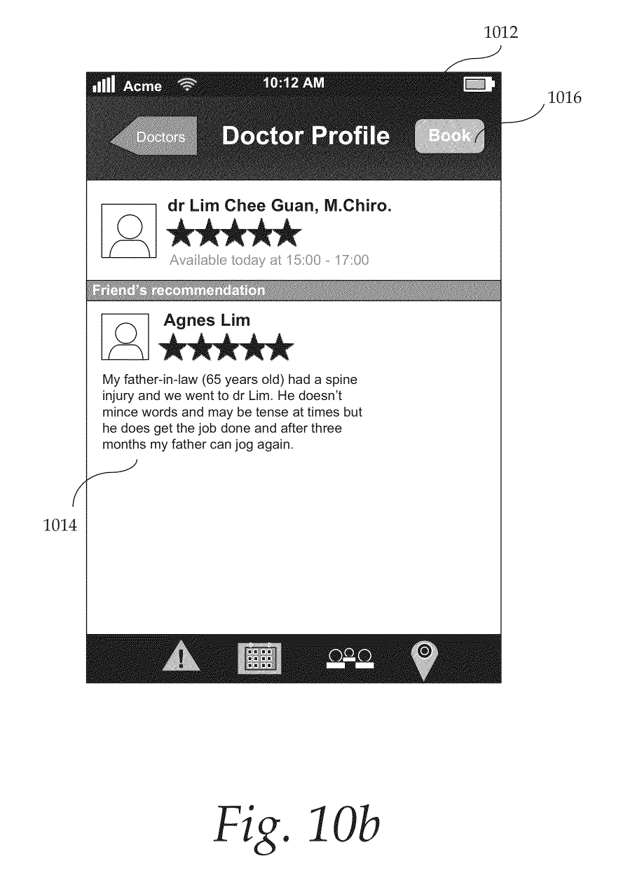

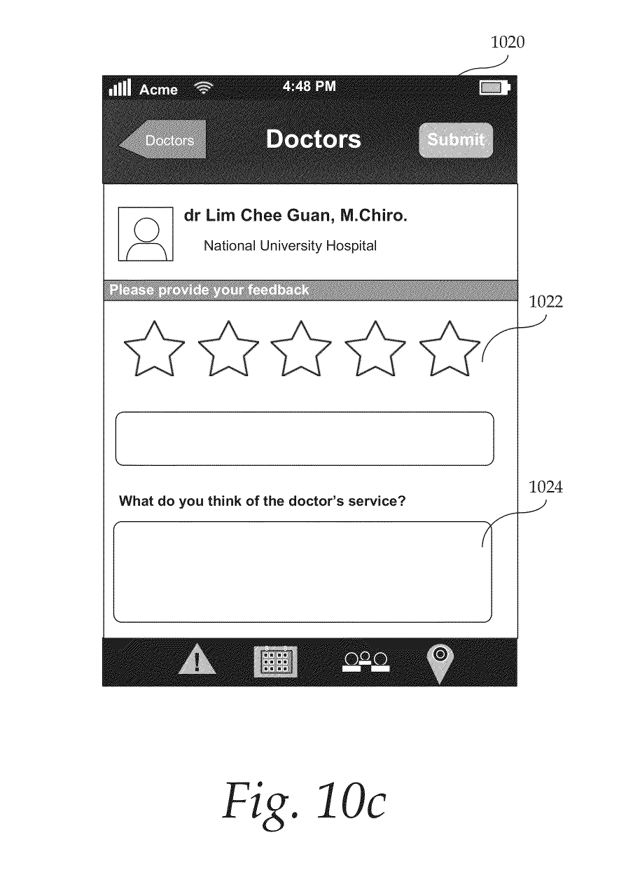

If re-scheduling is not required, the healthcare recipient receives healthcare from the healthcare provider, and the method continues to step 318. At 318, the dynamic appointment scheduler 126 determines if additional healthcare is required by the user. If so, steps 310, 312 and 314 are repeated for receiving the additional healthcare. If not, the method 300 continues at 320 to conclude the transaction. The user may proceed with payment for the healthcare and optionally review the healthcare provider. The user may submit the review via, for example, the exemplary dashboard 1020 as shown in FIG. 10c, as will be discussed later.

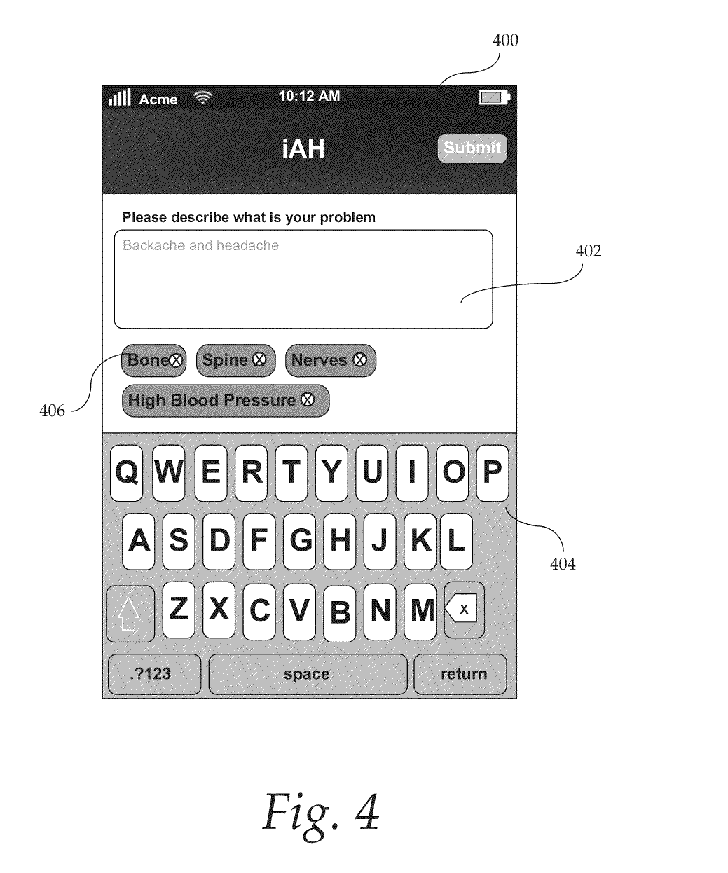

FIG. 4 shows an exemplary dashboard (or user interface) 400 presented by mobile application 153 for receiving healthcare need description. As shown, the dashboard 400 may include a text input box 402 for receiving user input describing the nature of a medical problem. User input may include, for example, text description, icons, photos, sound recordings, videos and/or measurement data. User input may be received via built-in components of the user device 152 (e.g., touch-screen keyboard 404, voice recognition engine, camera, microphone, etc.) or components coupled to the user device 152 (e.g., heart rate monitor, blood glucose meter, etc.). For example, measurement data may be stored in special purpose files that include measured values of patient characteristics, such as heart rate, blood pressure, blood glucose levels, etc. For instance, in the case of heart rate measurement data, the special purpose file may include a time series of measured heart rate or a special audio recording of heart beats.

Based on the user input, keywords 406 may be suggested to the user. The suggested keywords 406 may be presented while the user is entering the user input in, for example, text input box 402. The suggested keywords 406 are provided as feedback to the user to communicate what the recommendation engine 202 predicts is relevant to the healthcare need the user is trying to describe, and may be used by the recommendation engine 202 to generate a recommendation. The user may choose to remove one or more of the keywords 406 that the user deems irrelevant in order to aid the recommendation engine 202 in generating a more relevant recommendation.

In some implementations, the healthcare need description data may be automatically generated by the recommendation engine 202 based on the health record associated with the user. As discussed previously, health records database 122 may serve to store such health records. In some implementations, a health record is generated and maintained by using mobile application 153 implemented on the user device 152.

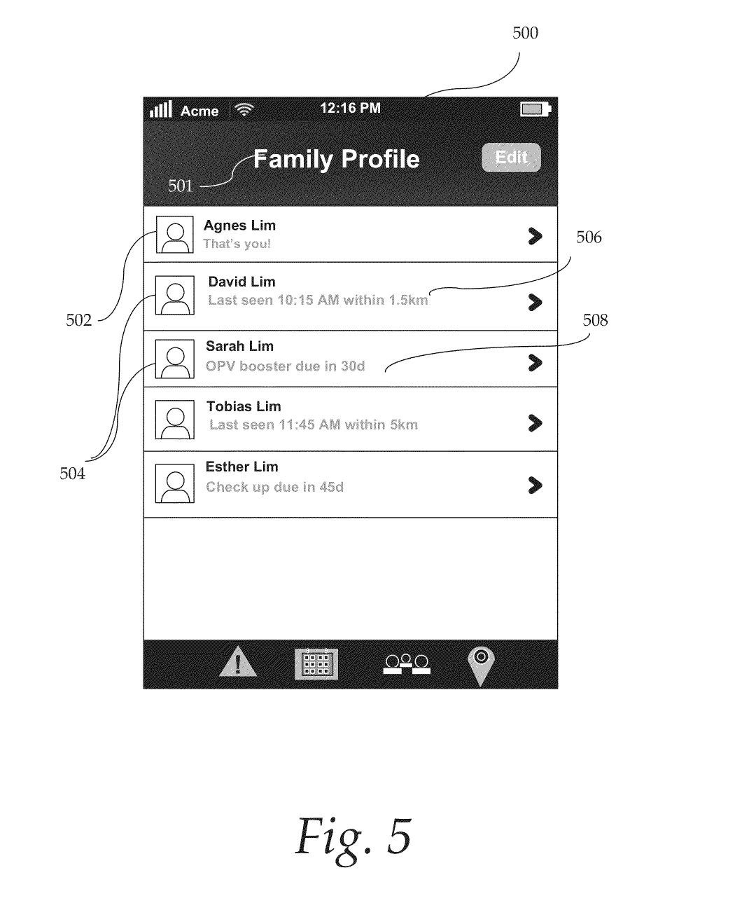

FIG. 5 shows an exemplary dashboard 500 presented by the mobile application 153 for managing a family profile 501. The dashboard 500 presents a family profile 501 that shows profile information of the user and all family members associated with the user. The user may edit the family profile 501 by adding or removing family members. The targeted type of user is the primary caregiver (e.g., mother, father, wife, most senior but productive family member, etc.) of a traditional nucleus family or extended family, since the primary caregiver typically has intrinsic interest in the well-being of the family. However, it should be appreciated that there may also be other types of users. The family profile 501 shows profile information associated with the user 502 as well as other family members 504. Such profile information may include, but is not limited to, the name, general location (e.g., last seen time and distance) 506, health alert 508 (e.g., reminder of next appointment), etc.

More particularly, the family profile 501 advantageously allows the user to view at a glance the near-future healthcare that the user and the user's family members may need. For example, as shown in FIG. 5, two family members—Sarah Lim and Esther Lim—have impending healthcare needs that need to be addressed. The user may directly schedule appointments via the dashboard 500 to address their healthcare needs.

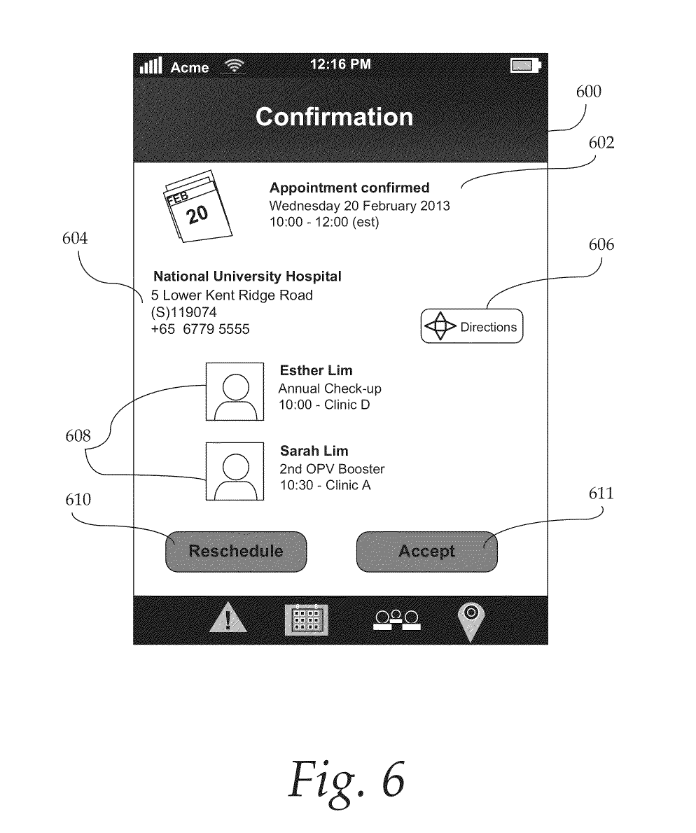

FIG. 6 shows an exemplary confirmation notification 600 of the appointment. As shown, the user may select to schedule a single composite appointment to take care of the healthcare needs of both family members 608 in, for example, half-day time span. By providing profile information of family members to view at a glance, the user is able to better plan his or her schedule to save time. It also provides cross-selling opportunities for the healthcare provider, as will be discussed in more detail later.

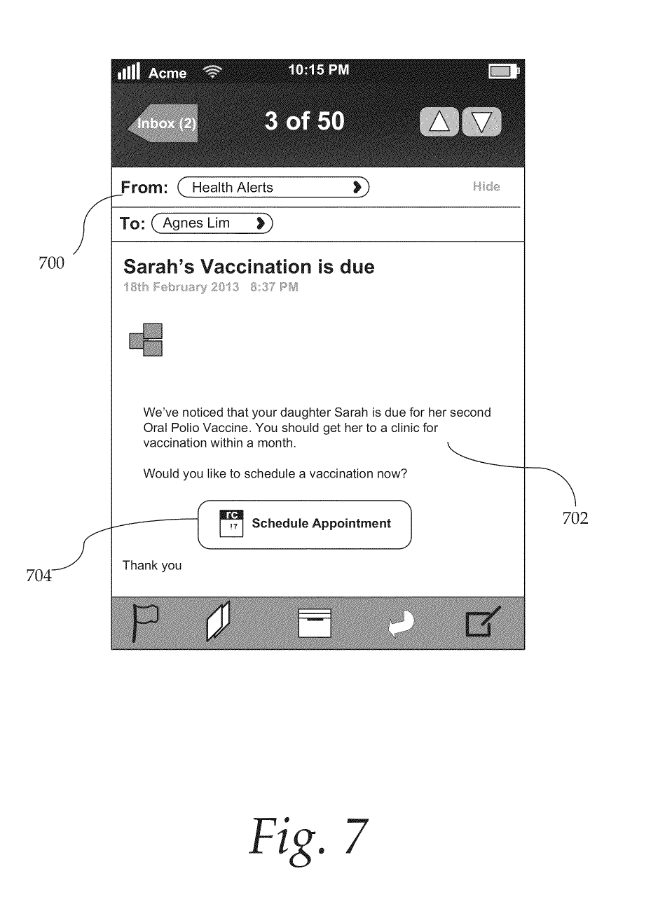

FIG. 7 shows an exemplary health alert 700. The health alert 700 provides another way of presenting a description of a healthcare need 702 of the user or the user's family member. As shown, the health alert 700 is in the form of an email. However, it should be appreciated that other forms, such as a text message or a push notification, may also be useful. Here, the healthcare need description 702 reminds the user that the user's family member is due for a vaccination. The health alert also provides the user with an option 704 to directly schedule an appointment to fulfill the healthcare need.

FIG. 8 shows an exemplary method 800 of generating a healthcare need description based on the health record of the user or the user's family member. The method 800 may be performed automatically or semi-automatically by the computer system 106, as previously described with reference to FIGS. 1 and 2.

At 802, a time-based event triggers the start of the method 800. The time-based event may occur periodically (e.g., weekly, monthly, etc.) based on, for example, the internal time of the computer system 106.

At 804, the recommendation engine 202 retrieves the health record of the user or the user's family member. In addition, the recommendation engine 202 may further retrieve preventive care guidelines. Preventive care guidelines may be retrieved from, for example, a public health database that includes national recommendations of healthcare schedule (e.g., vaccinations, well check-ups for children, etc.). Preventive care generally refers to measures taken in advance to prevent diseases or injuries rather than curing them or treating their symptoms.

At 806, the recommendation engine 202 determines if proactive healthcare is due. Proactive healthcare may include preventive care, as discussed previously. The recommendation engine 202 may match patient information (e.g., age) with preventive care guidelines to determine if any proactive healthcare is due. Proactive healthcare may also be directly prescribed by the patient's physician based on the patient's health condition. For example, the physician may recommend routine check-ups for a patient with a chronic disease (e.g., diabetes, heart disease, cancer, etc.). Such recommendations may be stored as part of the health record associated with the user or user's family member.

If no proactive healthcare is determined to be due, steps 802, 804 and 806 are repeated. If proactive healthcare is determined to be due, the method 800 continues at 808. A health alert may be sent to the user recommending the proactive healthcare. The health alert may be viewed by the user via, for example, the user device 152. The health alert may be in the form of an email, as shown in FIG. 7. As discussed previously, the health alert 700 may include a healthcare need description 702 that notifies the user of the recommended proactive healthcare.

Referring back to FIG. 8, at 810, the user may accept or reject the recommendation. User acceptance may be received via, for example, the user device 152. If the recommendation engine 202 does not receive user acceptance (e.g., user rejects recommendation or does not respond), at 812, the recommendation engine 202 notes that the recommendation is not required. If user acceptance is received, at 814, the recommendation engine 202 outputs the healthcare need description based on the proactive healthcare recommendation. The method may then continue at, for example, step 306 of method 300 as illustrated in FIG. 3.

FIG. 9 shows an exemplary method 306 of automatically generating a list of recommended healthcare providers. At 902, the recommendation engine 202 receives the healthcare need description and patient information. Patient information may include, but is not limited to, the health record of the patient, the patient's social connections (e.g. LinkedIn, Facebook, Sina Weibo, etc.), patient's demographic information, patient's current location or address of residence (e.g., known recent dwellings), and other relevant information.

At 904, the recommendation engine 202 may invoke the natural language processor 204 to parse the healthcare need description and patient information to extract relevant keywords (e.g., “vaccination”, “child”, etc.). The keywords may be presented to the user for the user to accept or reject. For example, the keywords may be presented as feedback to the user while the user is entering the healthcare need description. The user may choose to delete keywords that are deemed irrelevant to the healthcare need.

At 906, the recommendation engine 202 searches one or more databases using the relevant keywords to generate a list of recommended healthcare providers. The search may be performed on the healthcare marketplace database 124. The healthcare marketplace database 124 serves as a repository to store information associated with numerous healthcare providers including, but not limited to, location data, healthcare service profiles and social data. Social data may include, for example, reviews (e.g., ratings) from current or former patients of the healthcare providers, feedback to the healthcare providers from patients, and so forth. By providing a marketplace to search for healthcare providers, access reviews from other patients, and provide reviews and feedback to the healthcare provider, the user is empowered to make better informed decisions. Indeed, one of the reasons why traditional frameworks have failed commercially is because there is an absence of social elements in their offerings. By integrating inter-patient and patient-doctor communication with the entire healthcare experience, greater patient satisfaction and service utilization rate may be achieved.

In some implementations, the search is performed to find healthcare providers associated with one or more keywords in their service profiles that match the keywords (or synonyms) extracted from the healthcare need description. In addition, the search may also be performed to find healthcare providers in close vicinity or within a predetermined area (e.g., 5 mile radius) around the user's current location or place of residence. The list of healthcare providers may also include preferred healthcare providers or referrals stored in the user's health record. The user's social connections, current location or residence may also be used to find healthcare providers that have been reviewed by the user's social network. The user's social network generally refers to the community of people who are known to the user (e.g., friends) or are located close to the user. Further, the list may be filtered to include only healthcare providers with relatively high ratings or good reviews.

At 908, the list of healthcare providers is presented to the user. In some implementations, the list is presented to the user by the mobile application 153 implemented on the user device 152. FIG. 10a shows an exemplary dashboard 1002 for presenting a list of recommended healthcare providers 1004. An option element 1006 may also be presented to allow the user to select to view healthcare providers that are recommended by the user's social network. The name of each healthcare provider is presented, along the number of reviews 1008 and the overall rating 1010. The user may choose to read one or more reviews 1008 associated with each healthcare provider.

FIG. 10b shows an exemplary dashboard 1012 for presenting a review 1014 of a healthcare provider. As shown, the healthcare provider has been recommended by the user's friend. The user may read the review to make a better informed decision when selecting a healthcare provider. FIG. 10c shows an exemplary dashboard 1020 for receiving user feedback about a healthcare provider. The user may input a rating 1022 by, for example, selecting the number of “stars”. In addition, the user may also write a review in the text input box 1024.

FIG. 11 shows an exemplary method 308 of requesting for an appointment. At 1102, the dynamic appointment scheduler 126 receives an appointment request from the user. In some implementations, the appointment request from the user is received after the user inspects the list of recommended healthcare providers. As discussed previously with reference to FIG. 10a, the list may be presented by the mobile application 153 via a dashboard. The user may choose to read a review associated with a healthcare provider on the list, as discussed previously with reference to FIG. 10b. The dashboard 1012 provides an option 1016 for the user to remotely book a reservation with the selected healthcare provider. Once the user submits the booking, an appointment request may be communicated to the dynamic appointment scheduler 126. The appointment request may include, for example, the user's desired date and time for the appointment.

At 1104, in response to receiving the appointment request, the dynamic appointment scheduler 126 communicates the request to the selected healthcare provider's HIS to book the appointment.

At 1106, the dynamic appointment scheduler 126 determines if the booking is accepted by the healthcare provider. If the booking is rejected by the healthcare provider, the user is notified of the rejection and provided an opportunity to change the reservation request or select another healthcare provider. Steps 1102, 1104 and 1106 may then be repeated to re-submit another booking.

If the healthcare provider accepts the booking, at 1108, the HIS associated with the healthcare provider may send a booking confirmation to the user device 152. As discussed previously with reference to FIG. 6, the booking confirmation 600 may be in the form of a text message, an email or push notification at the user device 152. As shown in FIG. 6, the booking confirmation 600 may include information about the appointment, such as the date and time 602, the address of the healthcare provider 604, directions 606, patient information 608, and so forth. The booking confirmation 600 may also provide the user with an option to re-schedule 610 or to accept the booking 611.

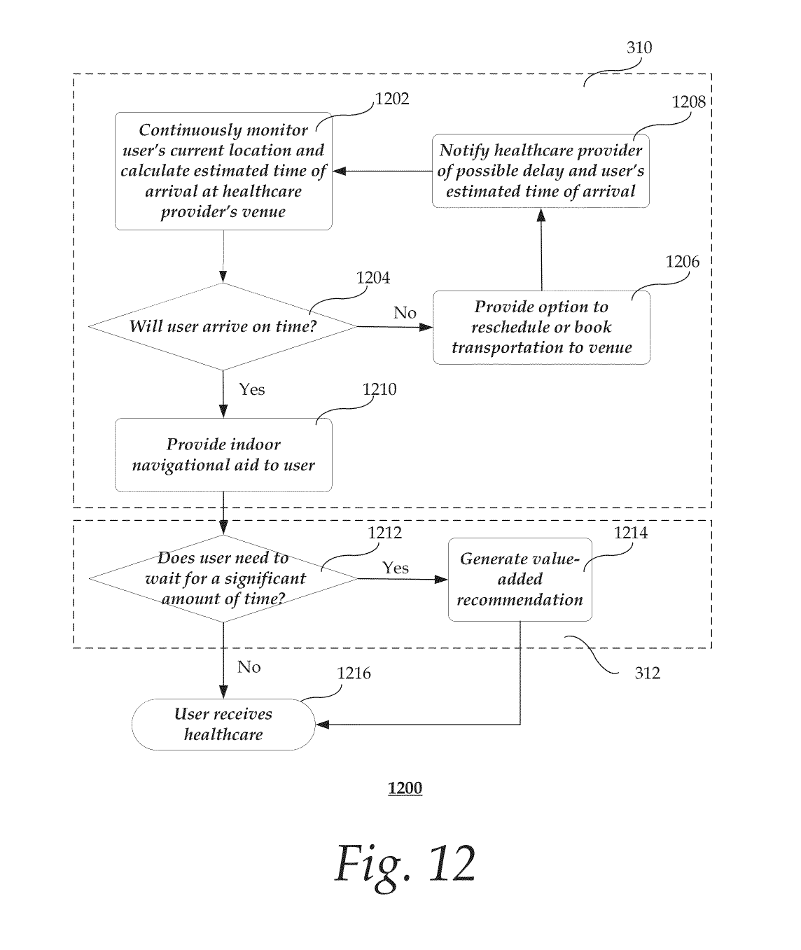

FIG. 12 shows an exemplary method 1200 of facilitating a visit to a healthcare provider and generating value-added recommendations during the visit. The method 1200 may be performed when performing steps 310 and 312 of method 300, as previously described with reference to FIG. 3.

At 1202, the dynamic appointment scheduler 126 continuously monitors the user's current location. In some implementations, the dynamic appointment scheduler 126 receives the user's current location information from the user device 152. The user device 152 may feed the dynamic appointment scheduler 126 with real-time location information from the outdoor navigation system 154 via the user device 152. The dynamic appointment scheduler 126 may also receive traffic information from the traffic prediction engine 208. The traffic prediction engine 208 may analyze traffic conditions in real time to determine, for example, any delays that may be caused by traffic congestion. Based on the location information and optionally the traffic information, the dynamic appointment scheduler 126 may then estimate the time of arrival of the user at the healthcare provider's venue.

At 1204, the dynamic appointment scheduler 126 determines if the user will arrive on time to fulfill the appointment. If the estimated time of arrival is much earlier or later than the appointment time, at 1206, the dynamic appointment scheduler 126 provides the user with an option to re-schedule. In some cases, the dynamic appointment scheduler 126 may provide the user with an option to book a faster mode of transportation to the venue. Such option may be presented to the user via the user device 152 in the form of, for example, an email, text message or push notification.

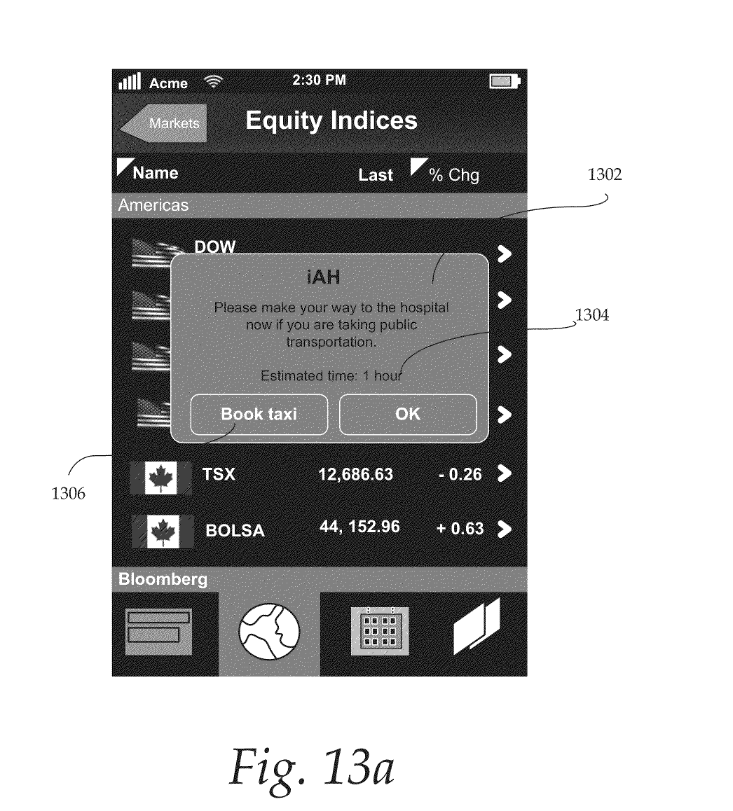

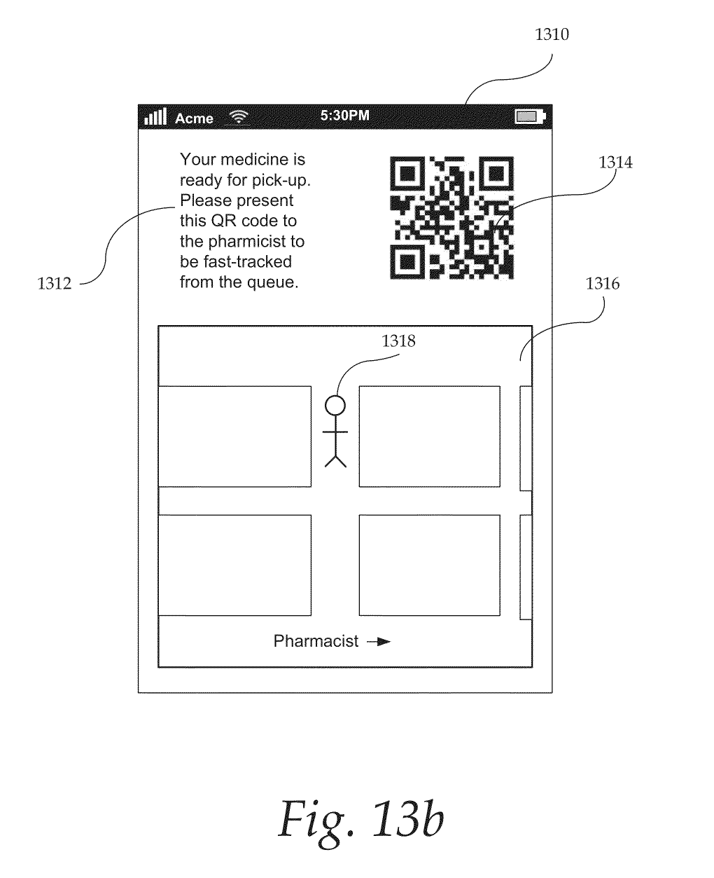

FIG. 13a shows an exemplary context-sensitive appointment alert 1302. The appointment alert 1302 may be presented in the form of a push notification via user device 152. Other forms of alert are also useful. The appointment alert 1302 may be presented when the user's appointment is imminent and the user is still a significant distance away from the venue of the healthcare provider. The appointment alert 1302 may also include the estimated time of arrival 1304, which is determined based on the user's current location. An option 1306 to utilize a faster mode of transportation (e.g., taxi) may also be presented. Should the user choose to book the transportation (e.g., taxi) to accelerate the arrival to the healthcare provider's venue, such transportation booking may be performed remotely via the user device 152. The dynamic appointment scheduler 126 may automatically provide the transportation partner with the user's current location, destination and contact information to facilitate the booking.

Referring back to FIG. 12, the method 1200 continues at 1208 to notify the healthcare provider of any possible delays and/or the user's estimated time of arrival.

If the user is determined to be able to arrive on time for the appointment, at 1210, the dynamic appointment scheduler 126 provides indoor navigational aid to the user after the user arrives at the venue. In some implementations, the dynamic appointment scheduler 126 invokes the mobile application 153 to present an indoor map to guide the user within the premises of the healthcare provider's venue (e.g., hospital). The user may be guided to the office of the healthcare service provider, pharmacy, or any other desired location. By providing the user with such navigational aid, the user need not be confined to the designated waiting area while waiting for the healthcare service.

FIG. 13b shows an exemplary dashboard 1310 presented by the mobile application 153 as a navigational aid. As shown, the dashboard 1310 includes an alert message 1312 notifying the user that the user's medicine is ready for pick-up at the pharmacist. A quick response (QR) code 1314 may also be presented to facilitate the pharmacist in tracking the prescription. An indoor map 1316 showing the current location 1318 of the user may also be presented. Turn-by-turn directions may be provided to assist the user in finding the pharmacy.

Returning back to FIG. 12, at 1212, the recommendation engine 202 determines if the user needs to wait for a significant amount of time (i.e. more than a pre-determined threshold value). For instance, the user may need to wait for custom medication to be prepared, receiving the healthcare, paperwork to be completed, and so forth. Another reason for a long waiting time can be due to the user arriving earlier.

If the waiting time is significant, at 1214, the recommendation engine 202 generates one or more value-added recommendations to distract the user during this time. Such recommendations advantageously allow healthcare providers and other providers to cross-sell their goods and services to the user. The recommendations may be related to, for instance, entertainment, food and/or other types of non-healthcare or healthcare (e.g., preventive) services. At 1216, the method 1200 ends when the user receives the healthcare.

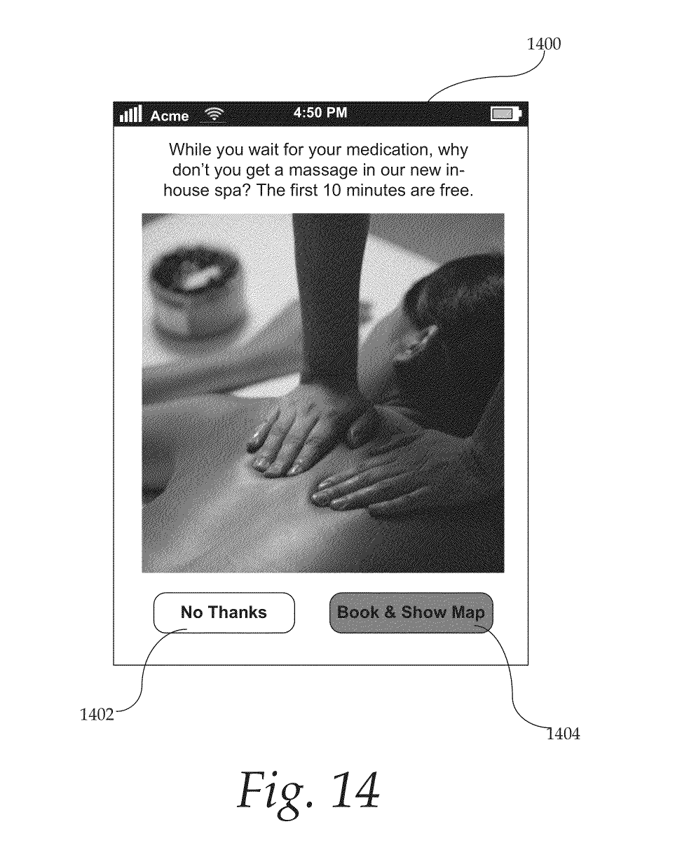

FIG. 14 shows an exemplary dashboard 1400 presented by the mobile application 153 that provides a recommendation for a massage service offered by an in-house spa. The user may choose to reject (or ignore) the recommendation via dashboard element 1402, or accept the recommendation and book a reservation via dashboard element 1404.

In accordance with some implementations, the present framework enables patients to start and continue queuing outside the healthcare provider's venue. In other words, patients need not physically wait at the designated waiting area to be in line for receiving healthcare. This saves the patient's time and reduces the required floor space in the designated waiting area. Context-sensitive alerts may be issued to the respective user device 152 when the appointment time is imminent (i.e. less than a pre-determined threshold time value) to remind the user to go to the designated waiting area.

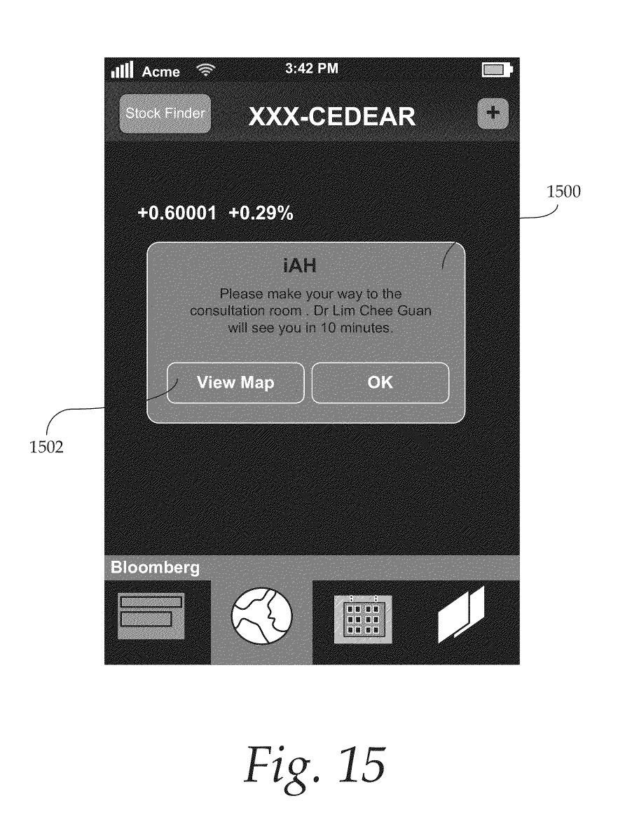

FIG. 15 shows an exemplary appointment alert 1500. Unlike the appointment alert 1302 previously described with reference to FIG. 13a that can be issued when the user is still outside the venue premises, the appointment alert 1500 may be issued while the user is within the premises of the healthcare provider's venue. As shown, the appointment alert 1500 reminds the user to make his or her way to the consultation room to receive healthcare. An option 1502 may further be presented to allow the user to view the map or to invoke any other navigational aid.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method of managing a healthcare visit, comprising:
receiving a healthcare need description associated with a user;
generating, by a processor, a list of recommended healthcare providers relevant to the healthcare need description;
receiving, via a user device, a user selection of a healthcare provider from the list;
requesting, by the processor, an appointment with the selected healthcare provider; and
facilitating, by the processor, a visit to fulfill the appointment.

2. A method of managing a healthcare visit, comprising:
receiving information of an appointment scheduled with a healthcare provider;
monitoring, by a processor, a user's real-time location;
facilitating, based on the user's real-time location, a visit to fulfill the appointment; and
if waiting time of the user during the visit is estimated to be more than a predetermined threshold value, presenting, via a user device, one or more recommendations of relevant services, goods or entertainment options to the user.

3. The method of claim 2 further comprising:
receiving a healthcare need description associated with a user;
generating, by the processor, a list of recommended healthcare providers relevant to the healthcare need description; and
receiving, via the user device, a user selection of a healthcare provider from the list.

4. The method of claim 3 further comprising receiving, via the user device, user input of the healthcare need description.

5. The method of claim 4 further comprising suggesting, based on the user input, one or more keywords as feedback to the user.

6. The method of claim 2 further comprising automatically generating, by the processor, a healthcare need description based on a health record associated with the user.

7. The method of claim 6 further comprising presenting, via the user device, a dashboard for the user to manage the health record.

8. The method of claim 7 further comprising presenting, via the dashboard, impending healthcare needs associated with the user or the user's family members.

9. The method of claim 6 wherein automatically generating the healthcare need description comprises:
retrieving the health record and preventive care guidelines from one or more databases;
determining if proactive healthcare is due based on the health record or the preventive care guidelines;
sending a health alert including a recommendation for the proactive healthcare; and
in response to receiving a user acceptance, providing the healthcare need description based on the recommendation.

10. The method of claim 3 wherein generating the list of recommended healthcare providers relevant to the healthcare need description comprises:
parsing the healthcare need description and patient information to extract one or more keywords; and
searching, using the one or more keywords, one or more databases to generate the list of recommended healthcare providers.

11. The method of claim 10 wherein the list of recommended healthcare providers includes one or more healthcare providers reviewed by the user's social network.

12. The method of claim 2 wherein facilitating the visit to fulfill the appointment comprises determining, based on the real-time location of the user, if re-scheduling the appointment is required.

13. The method of claim 12 wherein facilitating the visit to fulfill the appointment further comprises presenting the user with an option to re-schedule the appointment or to book a faster mode of transportation.

14. The method of claim 12 wherein the appointment comprises a composite appointment including multiple appointment items.

15. The method of claim 14 wherein if re-scheduling the appointment is required, the method further includes re-arranging a temporal order of the appointment items.

16. The method of claim 2 wherein facilitating the visit to fulfill the appointment comprises notifying the healthcare provider of the user's estimated time of arrival.

17. The method of claim 2 wherein facilitating the visit to fulfill the appointment comprises providing indoor navigational aid to the user after the user arrives at the healthcare provider's venue.

18. The method of claim 2 further comprising issuing one or more context-sensitive alerts to the user device when the appointment is imminent to remind the user to go to a designated waiting area.

19. The method of claim 2 further comprising concluding, via the user device, a transaction related to the visit.

20. A non-transitory computer-readable medium having stored thereon program code, the program code executable by a computer to:
receive information of an appointment scheduled with a healthcare provider;
monitor a user's real-time location;
facilitate, based on the user's real-time location, a visit to fulfill the appointment; and
if waiting time of the user during the visit is estimated to be more than a predetermined threshold value, present one or more recommendations of relevant services, goods or entertainment options to the user.

21. A system comprising:
a non-transitory memory device for storing computer-readable program code; and
a processor in communication with the memory device, the processor being operative with the computer-readable program code to
receive information of an appointment scheduled with a healthcare provider,
monitor a user's real-time location,
facilitate, based on the user's real-time location, a visit to fulfill the appointment, and
if waiting time of the user during the visit is estimated to be more than a predetermined threshold value, present one or more recommendations of relevant services, goods or entertainment options to the user.
